(19) United States
(12) Patent Application Publication
(10) Pub. No.: US 2026/0274576 A1
(43) Pub. Date: Sep. 17, 2026

(54) FLOW RAIL SYSTEM AND PALLET STOP APPARATUS

(71) Applicant: Woodsage LLC., Holland, OH (US)

(72) Inventors: Patrick Cucco, Ashland, OH (US); Rodger Brian Davis, Mansfield, OH (US)

(73) Assignee: Woodsage LLC, Holland, OH (US)

(21) Appl. No.: 19/565,923

(22) Filed: Mar. 13, 2026

Related U.S. Application Data
(60) Provisional application No. 63/771,322, filed on Mar. 13, 2025.

(51) Int. Cl. B65G 1/137; B65G 47/88

(52) U.S. Cl. CPC B65G 1/1378; B65G 47/8838

(57) ABSTRACT

A flow rail system and pallet stop for the flow rail system are provided. The pallet stop may include a bracket, an axle, a plunger, a roller, and a compression spring. The bracket includes two substantially parallel tabs. The axle may be configured to extend between the two substantially parallel tabs. The plunger may include a first axial opening configured to receive at least a portion of the axle. The plunger may be coaxial with the axle. The roller may include a second axial opening configured to receive the plunger. The roller may be coaxial with the plunger. The compression spring may be disposed in the second axial opening of the roller. The compression spring may be configured to be compressed between the plunger and the roller. The compression spring may be configured to provide a drag force to the roller.

### CROSS-REFERENCE TO RELATED APPLICATIONS

This application claims priority to U.S. Provisional Application No. 63/771,322, filed on March 13, 2025, which is incorporated by reference in its entirety.

### FIELD OF DISCLOSURE

This application generally relates to a flow rail system and a pallet stop apparatus for the flow rail system.

### BACKGROUND

Flow rail systems provide for movement of pallets within a warehouse. They typically utilize gravity to move pallets along inclined frames. The flow rail systems may include a pallet stop at an end of the system at which a pallet may be removed from the flow rail system. The pallet stop generally includes a free spinning roller which may cause a pallet being removed to fall quickly.

### SUMMARY

In some embodiments, a pallet stop for a flow rail system is provided. The pallet stop may include a bracket, an axle, a plunger, a roller, and a compression spring. The bracket includes two substantially parallel tabs. The axle may be configured to extend between the two substantially parallel tabs. The plunger may include a first axial opening configured to receive at least a portion of the axle. The plunger may be coaxial with the axle. The roller may include a second axial opening configured to receive the plunger. The roller may be coaxial with the plunger. The compression spring may be disposed in the second axial opening of the roller. The compression spring may be configured to be compressed between the plunger and the roller. The compression spring may be configured to provide a drag force to the roller.

In some embodiments, a flow rail system is provided. The flow rail system may include a longitudinal portion, a plurality of rolling elements, and a pallet stop. The plurality of rolling elements may be disposed in the longitudinal portion. The plurality of rolling elements may extend above a top surface of the longitudinal portion. The pallet stop may be disposed at an end of the longitudinal portion. The pallet stop may include a bracket, an axle, a plunger, a roller, and a compression spring. The bracket may include two substantially parallel tabs. The axle may be configured to extend between the two substantially parallel tabs. The plunger may include a first axial opening configured to receive at least a portion of the axle. The plunger may be coaxial with the axle. The roller may include a second axial opening configured to receive the plunger. The roller may be coaxial with the plunger. The compression spring may be disposed in the second axial opening of the roller. The compression spring may be configured to be compressed between the plunger and the roller. The compression spring may be configured to provide a drag force to the roller. The pallet stop may extend above a top surface of the plurality of rolling elements.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 depicts an illustrative flow rail system with an illustrative pallet stop, in accordance with example embodiments.

FIG. 2 depicts a side view of an illustrative flow rail system with an illustrative pallet stop, in accordance with example embodiments.

FIG. 3 depicts an exploded view of a pallet stop, in accordance with example embodiments.

FIG. 4 depicts a top view of a pallet stop, in accordance with example embodiments.

FIG. 5 depicts a side view of a pallet stop, in accordance with example embodiments.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

One or more techniques described herein improve upon conventional systems by providing a pallet stop which may provide a controlled manner for removal of empty pallets from a flow rail by providing a drag force on a roller of the pallet stop. With a freely spinning roller on a pallet stop, an empty pallet may fall faster due to gravity and the lack of friction in freely spinning rollers. This may cause muscle strain, sprains, or worse injury in those removing the pallets from the flow rail. Providing a drag force on the roller of a pallet stop may resist the gravitational effects on the empty pallet causing the pallet to roll down slower as it is removed which may provide for less muscle strain and lower potential of sprains and other injuries in those removing the pallets.

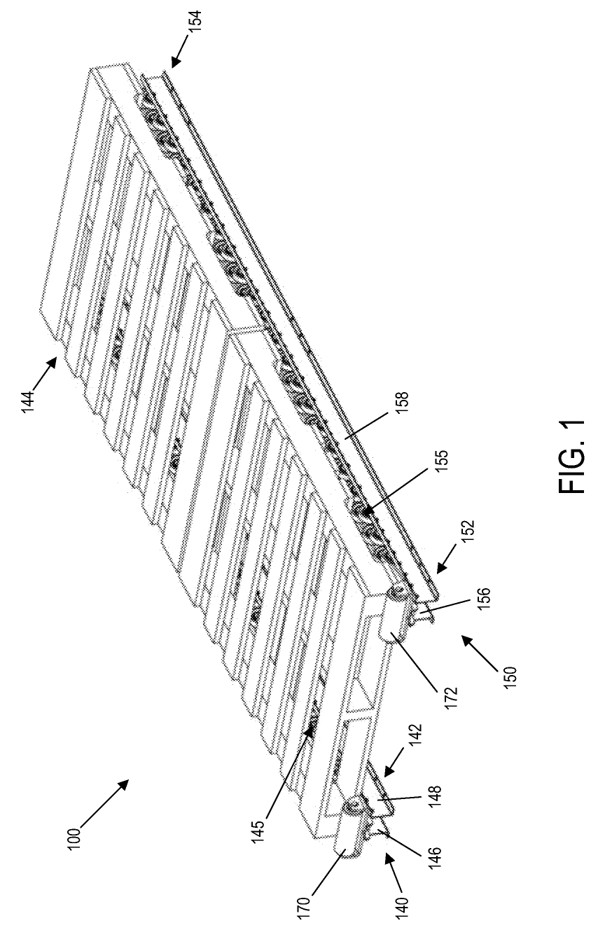

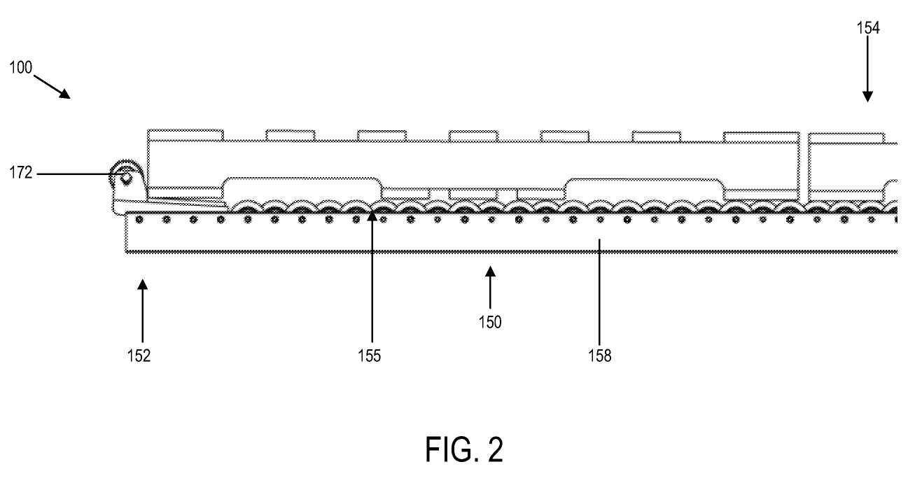

FIGS. 1-2 illustrate a flow rail system 100, according to example embodiments. Flow rail system 100 includes a first longitudinal portion 140 and a second longitudinal portion 150. First longitudinal portion 140 may be substantially parallel with second longitudinal portion 150. First longitudinal portion 140 may be spaced from second longitudinal portion 150, such that an object, such as a pallet, can be supported by both the first longitudinal portion 140 and the second longitudinal portion 150. Although not shown, flow rail system 100 may include a support structure configured to support the first longitudinal portion 140 and the second longitudinal portion 150. The support structure may take the form, for example, of one or more components that run perpendicular to first longitudinal portion 140 and second longitudinal portion 150.

First longitudinal portion 140 may have a first end 142 opposite a second end 144. First longitudinal portion 140 may include a first longitudinal section 146, a second longitudinal section 148, and a plurality of rolling elements 145. Each of first longitudinal section 146 and second longitudinal section 148 may extend from first end 142 to second end 144. For example, each of first longitudinal section 146 and second longitudinal section 148 may have substantially the same length. The plurality of rolling elements 145 may be disposed between first longitudinal section 146 and second longitudinal section 148, such that a top portion of each rolling element of the plurality of rolling elements 145 may extend above the top surfaces of first longitudinal section 146 and second longitudinal section 148. In this manner, when an object, such as a pallet is placed onto first longitudinal portion 140, the object may interface directly with the plurality of rolling elements 145. In some embodiments, the plurality of rolling elements 145 may be representative of wheels. In some embodiments, the plurality of rolling elements 145 may be representative of rollers.

Second longitudinal portion 150 may have a first end 152 opposite a second end 154. Second longitudinal portion 150 may include a first longitudinal section 156, a second longitudinal section 158, and a plurality of rolling elements 155. Each of first longitudinal section 156 and second longitudinal section 158 may extend from first end 152 to second end 154. For example, each of first longitudinal section 156 and second longitudinal section 158 may have substantially the same length. The plurality of rolling elements 155 may be disposed between first longitudinal section 156 and second longitudinal section 158, such that a top portion of each rolling element of the plurality of rolling elements 155 may extend above the top surfaces of first longitudinal section 156 and second longitudinal section 158. In this manner, when an object, such as a pallet is placed onto first longitudinal portion 140, the object may interface directly with the plurality of rolling elements 155. In some embodiments, the plurality of rolling elements 155 may be representative of wheels. In some embodiments, the plurality of rolling elements 155 may be representative of rollers.

As shown, a top surface of each rolling element of the plurality of rolling elements 145 may extend above the top surfaces of the first longitudinal section 146 and the second longitudinal section 148 by the same amount as the plurality of rolling elements 155 extend above the top surfaces of the first longitudinal section 156 and the second longitudinal section 158. In this manner, when an object, such as a pallet, is placed on the flow rail system 100, a top surface of the object is sufficiently level.

As those skilled in the art understand, flow rail systems, such as those used in the context of gravity rollers, rely on the mass of the object and gravity, for moving an object from one end of the flow rail system to the other end of the flow rail system. When dealing with heavy or bulky objects, the speed at which an object placed on the flow rail system can move from the first end to the second end may be significant and can result in possible injury to operators removing objects from the second end of the flow rail system. To account for this, flow rail system 100 may include pallet stop apparatus 170 and pallet stop apparatus 172.

Pallet stop apparatus 170 may be disposed at one of the first end 142 or the second end 144 of first longitudinal portion 140. For purposes of this discussion, FIG. 1 illustrates pallet stop apparatus 170 positioned at first end 142. Pallet stop apparatus 170 may be coupled with first longitudinal portion 140 such that a body of pallet stop apparatus 170 extends substantially above a top surface of the plurality of rolling elements 145. Pallet stop apparatus 172 may similarly be disposed at one of the first end 152 or the second end 154 of second longitudinal portion 150. For purposes of this discussion, FIG. 1 illustrates pallet stop apparatus 172 positioned at first end 152. Pallet stop apparatus 172 may be coupled with second longitudinal portion 150 such that a body of pallet stop apparatus 172 extends substantially above a top surface of the plurality of rolling elements 155. In operation, pallet stop apparatus 170 and pallet stop apparatus 172 may work in conjunction to stop the flow or movement of objects from one end of the flow rail system 100 to the other end of the flow rail system 100, such that the objects do not fly off the flow rail system 100.

Each of pallet stop apparatus 170 and pallet stop apparatus 172 may be inclined or pitched, such that an operator can raise an edge of an object, such as a pallet, over pallet stop apparatus 170 and pallet stop apparatus 172, to provide easier access for the operator to remove the pallet from the flow rail system 100.

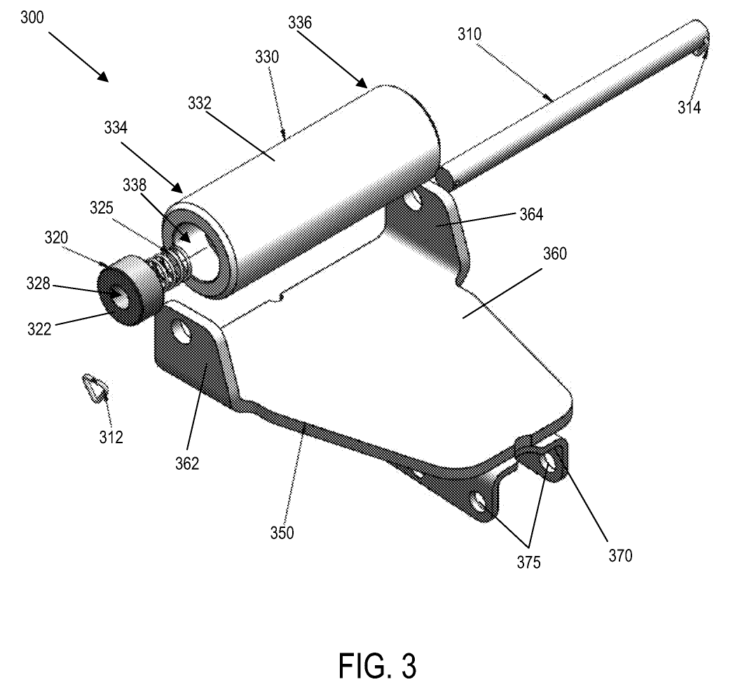

FIGS. 3-5 illustrate several views of a pallet stop apparatus 300, in accordance with example embodiments. Pallet stop apparatus 300 may be representative of pallet stop apparatus 170 and pallet stop apparatus 172. Pallet stop apparatus 300 may include an axle 310, a plunger 320, a roller 330, a compression spring 325, and a bracket 350.

Roller 330 may include a cylindrical body 332 having a first end 334 and a second end 336. In some embodiments, cylindrical body 332 may have a radius in the range of about 1.8 inches to about 3.5 inches. In some embodiments, the cylindrical body 332 may have a radius larger than 1.8 inches. In some embodiments, cylindrical body 332 may have a radius less than 3.5 inches. Cylindrical body 332 may define an axial opening 338 formed therein. For example, axial opening 338 may extend from first end 334 of cylindrical body 332 to second end 336 of cylindrical body 332. Axial opening 338 may be configured to selectively interface with axle 310. In some embodiments, axial opening 338 may have a constant radius from first end 334 to second end 336. In some embodiments, axial opening 338 may have varied radii.

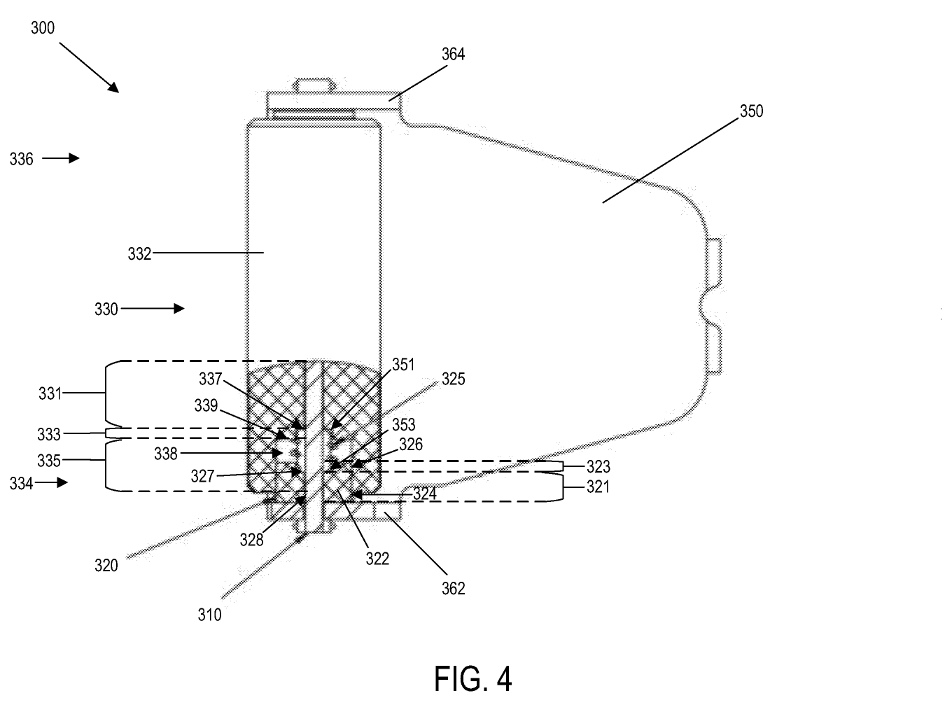

For example, as better illustrated in FIG. 4, portions of axial opening 338 near first end 334 and/or second end 336 may have a larger radius compared to other portions of axial opening 338. A first portion 331 of axial opening 338 may have a radius approximately equal to a radius of axle 310 such that first portion 331 of axial opening 338 may more tightly or closely envelop axle 310. A second portion 333 of axial opening 338 may have a radius larger than the radius of first portion 331 such that cylindrical body 332 is spaced farther apart from axle 310. In some embodiments, the radius of the second portion 333 of axial opening 338 may be approximately equal to a radius of compression spring 325 such that the second portion 333 of axial opening 338 may more tightly or closely envelop the compression spring 325. A third portion 335 of axial opening 338 may have a radius larger than the radius of the second portion 333 of axial opening 338 such that cylindrical body 332 is spaced farther apart from axle 310. In some embodiments, the radius of the third portion 335 of axial opening 338 may be approximately equal to a radius of plunger 320 such that the third portion 335 of axial opening 338 may more tightly or closely envelop the plunger 320. Thus, the axial opening 338 may represent a stepping pattern in at least one end of cylindrical body 332 and may include at least a first step 337 and a second step 339. First step 337 may be a surface of cylindrical body 332 substantially perpendicular to a center line of roller 330 at the meeting of the first portion of axial opening 338 and the second portion 333 of axial opening 338. Second step 339 may be a surface substantially perpendicular to the center line of cylindrical body 332 at the meeting of the second portion 333 of axial opening 338 and the third portion 335 of axial opening 338.

Plunger 320 may be at least partially disposed in one of first end 334 or second end 336 of cylindrical body 332, such that roller 330 may surround at least a portion of plunger 320 when plunger 320 is engaged with roller 330. As shown in FIG. 4, plunger 320 is disposed in first end 334. Plunger 320 may include a cylindrical body 322 having a first end 324 and a second end 326. Cylindrical body 322 may define an axial opening 328 formed therein. For example, axial opening 328 may extend from first end 324 of cylindrical body 322 to second end 326 of cylindrical body 322. Axial opening 328 may be configured to selectively interface with axle 310 for passage therethrough. In some embodiments, axial opening 328 may be substantially concentric with axial opening 338. In some embodiments, axial opening 328 may have varied radii.

For example, as better illustrated in FIG. 4, portions of axial opening 328 near first end 324 and/or second end 326 may have a larger radius compared to other portions of axial opening 328. A first portion 321 of axial opening 328 may have a radius approximately equal to a radius of axle 310 such that axial opening 328 may more tightly or closely envelop axle 310. A second portion 323 of axial opening 328 may have a radius larger than first portion 321 of axial opening 328 such that cylindrical body 322 is spaced further apart from axle 310. In some embodiments, the radius of the second portion 323 of axial opening 328 may be approximately equal to a radius of compression spring 325 such that second portion 323 of axial opening 328 may more tightly or closely envelop compression spring 325. Thus, the axial opening 328 may represent a stepping pattern in at least one end of cylindrical body 322 and may include at least a first step 327. First step 327 may be formed in an inner surface of cylindrical body 322 substantially perpendicular to a center line of plunger 320 at the interface of the first portion of axial opening 328 and the second portion of axial opening 328.

Compression spring 325 may be at least partially disposed in one of the first end 334 and second end 336 of cylindrical body 332, such that roller 330 may surround at least a portion of compression spring 325. Compression spring 325 may be helically shaped, defining an opening along a center line of the helical shape. The opening of compression spring 325 may be substantially concentric with axial opening 328 and axial opening 338. In this manner, plunger 320, roller 330, and compression spring 325 may be coaxial with axle 310. Compression spring 325 may be at least partially disposed between plunger 320 and roller 330. Compression spring 325 may be disposed between the second portion 323 of axial opening 328 and the second portion 333 of axial opening 338 such that a first end 351 of compression spring 325 may interface with a portion of cylindrical body 322 and a second end 353 of compression spring 325 may interface with a portion of cylindrical body 332. For example, the first end 351 of compression spring 325 may interface with first step 327 of axial opening 328 such that compression spring 325 may be compressed against first step 327. The second end 353 of compression spring 325 may interface with the first step 337 of axial opening 338 such that compression spring 325 may be compressed against first step 337.

In operation, when plunger 320 is engaged with roller 330, compression spring 325 may be compressed. As compression spring 325 is compressed by plunger 320, compression spring 325 may exert a drag force on roller 330 impeding the rotation of roller 330. As one of ordinary skill in the art will understand, the drag force value may vary based on the characteristics of compression spring 325. For example, a compression spring 325 with a higher spring constant may provide a higher value drag force than a compression spring 325 with a lower spring constant. Thus, compression spring 325 may be chosen based on how much drag force is desired. In order to hold compression spring 325 in place providing a drag force to roller 330, bracket 350 may be provided to hold plunger 320 in roller 330 providing a substantially constant compression of compression spring 325.

Bracket 350 may be configured to secure pallet stop apparatus 300 to a flow rail system, such as flow rail system 100. Bracket 350 may include a top portion 360 and a bottom portion 370. Top portion 360 may include a first tab 362 and a second tab 364 substantially opposite first tab 362. First tab 362 and second tab 364 may be substantially parallel. Bottom portion 370 may be configured to connect bracket 350 to the flow rail system 100. First tab 362 and second tab 364 may be spaced apart to hold plunger 320 at a set depth in roller 330. The set depth may allow plunger 320 to compress compression spring 325 in axial opening 338 of roller 330 at a substantially constant compression. In some embodiments, roller 330 and plunger 320 may be formed from or include ultra-high-molecular-weight polyethylene (UHMW) sleeve. UHMW provides abrasion, impact, and wear resistance while also performing well in low temperature environments which may extend the life of pallet stop apparatus 300. First tab 362 and second tab 364 of bracket 350 may be made of a sturdy material configured to constrain compression spring 325 and provide a substantially constant drag force to roller 330. In some embodiments, bracket 350 may include steel, stainless steel, and/or zinc-plated steel. First tab 362 and second tab 364 may each include an opening defined therein configured to allow axle 310 to pass therethrough. Axle 310 may be configured to support roller 330, plunger 320, and compression spring 325 in between first tab 362 and second tab 364. Axle 310 may be secured in place between first tab 362 and second tab 364 via one or more pins 312, 314.

When roller 330, compression spring 325, and plunger 320 are inserted between first tab 362 and second tab 364, compression spring 325 may be compressed creating a pressure between roller 330 and plunger 320. The force exerted on both roller 330 and plunger 320 by compression spring 325 while roller 330 and plunger 320 are contained by first tab 362 and second tab 364 may provide at least one of friction between compression spring 325 and roller 330, friction between compression spring 325 and plunger 320, friction between plunger 320 and first tab 362, and/or friction between roller 330 and second tab 364. The friction may result in a drag force on roller 330, thus impeding the rotation of roller 330. As one of ordinary skill in the art will understand, varying at least one of the spacing between first tab 362 and second tab 364, the length of compression spring 325, the spring constant of compression spring 325, the length of plunger 320, the depth of first step 327, the depth of first step 337, and the length of roller 330 may vary the drag force.

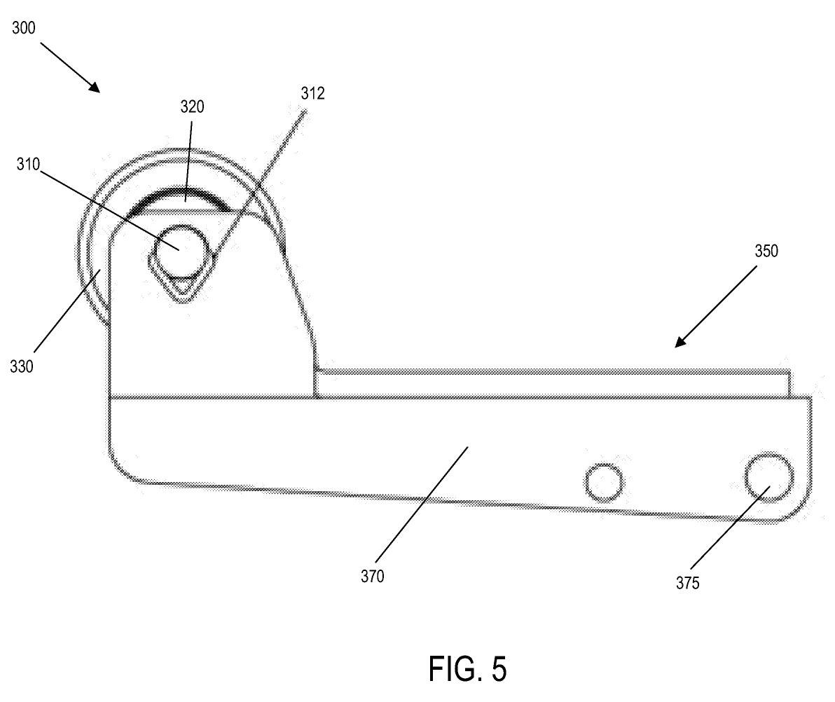

As illustrated in FIG. 5, bottom portion 370 of bracket 350 may be configured to secure bracket 350 to the flow rail system 100 via at least one of longitudinal portion 140 or longitudinal portion 150. In some embodiments, bottom portion 370 may include one or more holes 375. Bracket 350 may be secured to the flow rail system 100, as shown in FIGS. 1 and 2, via one or more coupling mechanisms, such as, but not limited to, screws, bolts, pins, or the like.

Additional examples of the presently described method and device embodiments are suggested according to the structures and techniques described herein. Other non-limiting examples may be configured to operate separately or may be combined in any permutation or combination with any one or more of the other examples provided above or throughout the present disclosure.

It will be appreciated by those skilled in the art that the present disclosure may be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language "means for" or "step for" be interpreted under 35 U.S.C. 112(f). Claims that do not expressly include the phrase "means for" or "step for" are not to be interpreted under 35 U.S.C. 112(f).

1. A pallet stop apparatus for a flow rail system, comprising:
a bracket comprising two substantially parallel tabs;
an axle configured to extend between the two substantially parallel tabs;
a plunger comprising a first axial opening configured to receive at least a portion of the axle, the plunger coaxial with the axle;
a roller comprising a second axial opening configured to receive the plunger, the roller coaxial with the plunger; and
a compression spring disposed in the second axial opening of the roller, the compression spring configured to be compressed between the plunger and the roller;
wherein the compression spring is configured to provide a drag force to the roller.

2. The pallet stop apparatus of claim 1, wherein the plunger comprises:
a first end configured to interface with a first tab of the two substantially parallel tabs; and
a second end configured to interface with the compression spring in the second axial opening of the roller.

3. The pallet stop apparatus of claim 2, wherein the roller further comprises:
a first end; and
a second end opposite the first end,
wherein the second end is configured to interface with a second tab of the two substantially parallel tabs.

4. The pallet stop apparatus of claim 3, wherein the compression spring provides a pressure between the roller held by the second tab and the plunger held by the first tab.

5. The pallet stop apparatus of claim 1, wherein the axle is held in place between the two substantially parallel tabs by a pin on either end of the axle.

6. The pallet stop apparatus of claim 1, wherein the bracket comprises steel.

7. The pallet stop apparatus of claim 1, wherein the bracket comprises:
a top portion comprising the two substantially parallel tabs; and
a bottom portion configured to connect to a flow rail system.

8. The pallet stop apparatus of claim 1, wherein the roller comprises ultra-high-molecular-weight polyethylene (UHMW) and wherein the plunger comprises UHMW.

9. The pallet stop apparatus of claim 1, wherein the second axial opening comprises:
a first portion having a first radius;
a second portion having a second radius larger than the first radius; and
a third portion having a third radius larger than the second radius;
wherein the first portion is configured to receive the axle,
wherein the second portion is configured to receive the compression spring, and
wherein the third portion is configured to receive the plunger.

10. The pallet stop apparatus of claim 1, wherein the first axial opening comprises:
a first portion having a first radius; and
a second portion having a second radius;
wherein the first portion is configured to receive the axle, and
wherein the second portion is configured to receive the compression spring.

11. A flow rail system, comprising:
a longitudinal portion;
a plurality of rolling elements disposed in the longitudinal portion, the plurality of rolling elements extending above a top surface of the longitudinal portion; and
a pallet stop disposed at an end of the longitudinal portion, the pallet stop comprising:
a bracket comprising two substantially parallel tabs;
an axle configured to extend between the two substantially parallel tabs;
a plunger comprising a first axial opening configured to receive at least a portion of the axle, the plunger coaxial with the axle;
a roller comprising a second axial opening configured to receive the plunger, the roller coaxial with the plunger; and
a compression spring disposed in the second axial opening of the roller, the compression spring configured to be compressed between the plunger and the roller;
wherein the compression spring is configured to provide a drag force to the roller, and
wherein the pallet stop extends above a top portion of the plurality of rolling elements.

12. The flow rail system of claim 11, wherein the plunger comprises:
a first end configured to interface with a first tab of the two substantially parallel tabs; and
a second end configured to interface with the compression spring in the second axial opening of the roller.

13. The flow rail system of claim 12, wherein the roller further comprises:
a first end; and
a second end opposite the first end,
wherein the second end is configured to interface with a second tab of the two substantially parallel tabs.

14. The flow rail system of claim 13, wherein the compression spring provides a pressure between the roller held by the second tab and the plunger held by the first tab.

15. The flow rail system of claim 11, wherein the axle is held in place between the two substantially parallel tabs by a pin on either end of the axle.

16. The flow rail system of claim 11, wherein the bracket comprises steel.

17. The flow rail system of claim 11, wherein the bracket comprises:
a top portion comprising the two substantially parallel tabs; and
a bottom portion configured to connect to the longitudinal portion.

18. The flow rail system of claim 11, wherein the roller comprises ultra-high-molecular-weight polyethylene (UHMW) and wherein the plunger comprises UHMW.

19. The flow rail system of claim 11, wherein the longitudinal portion is a first longitudinal portion, wherein the plurality of rolling elements is a first plurality of rolling elements, and wherein the pallet stop is a first pallet stop, the flow rail system further comprising:
a second longitudinal portion spaced apart from the first longitudinal portion, the second longitudinal portion substantially parallel to the first longitudinal portion;
a second plurality of rolling elements disposed in the second longitudinal portion, the second plurality of rolling elements extending above a top surface of the second longitudinal portion; and
a second pallet stop disposed at an end of the second longitudinal portion,
wherein the second pallet stop is substantially identical to the first pallet stop, and
wherein the second pallet stop extends above a top portion of the second plurality of rolling elements.

20. The flow rail system of claim 11, wherein the second axial opening comprises:
a first portion having a first radius;
a second portion having a second radius larger than the first radius; and
a third portion having a third radius larger than the second radius;
wherein the first portion is configured to receive the axle,
wherein the second portion is configured to receive the compression spring, and
wherein the third portion is configured to receive the plunger.
